(19) United States
(12) Patent Application Publication
(10) Pub. No.: US 2011/0255597 A1
(43) Pub. Date: Oct. 20, 2011

(54) Method and System for Reducing Flicker Artifacts

(76) Inventors: Tomonobu Mihara, Katsushika-ku (JP); Akira Osamoto, Plano, TX (US)

(21) Appl. No.: 12/762,349

(22) Filed: Apr. 18, 2010

(51) Int. Cl. H04N 7/32

(52) U.S. Cl. 375/240.16; 375/E07.243

(57) ABSTRACT

A method of encoding a frame of a digital video sequence as an intracoded frame (I-frame) is provided that includes performing motion estimation on a macroblock of the frame to compute a motion estimation measure and a motion vector for the macroblock, wherein a previous original frame of the digital video sequence that was encoded as a predictive coded frame (P-frame) is used as a reference frame, and selectively encoding the macroblock or a motion-compensated macroblock from a reconstructed P-frame based on the motion estimation measure and an adaptive flicker threshold, wherein the reconstructed P-frame was generated by decoding the P-frame.

### BACKGROUND OF THE INVENTION

The demand for digital video products continues to increase. Some examples of applications for digital video include video communication, security and surveillance, industrial automation, and entertainment (e.g., DV, HDTV, satellite TV, set-top boxes, Internet video streaming, digital cameras, cellular telephones, video jukeboxes, high-end displays and personal video recorders). Further, video applications are becoming increasingly mobile as a result of higher computation power in handsets, advances in battery technology, and high-speed wireless connectivity.

Video compression is an essential enabler for digital video products. Compression-decompression (CODEC) algorithms enable storage and transmission of digital video. In general, the encoding process of video compression generates coded representations of frames or subsets of frames. The encoded video bitstream, i.e., encoded video sequence, may include three types of frames: intracoded frames (I-frames), predictive coded frames (P-frames), and bi-directionally coded frames (B-frames). I-frames are coded without reference to other frames. P-frames are coded using motion compensated prediction from I-frames or P-frames. B-frames are coded using motion compensated prediction from both past and future reference frames. For encoding, all frames are divided into coding units, e.g., 16×16 macroblocks of pixels in the luminance space and 8×8 macroblocks of pixels in the chrominance space for the simplest sub-sampling format.

Video coding standards (e.g., MPEG, H.264, etc.) are based on the hybrid video coding technique of block motion compensation and transform coding. Block motion compensation is used to remove temporal redundancy between blocks of a frame and transform coding is used to remove spatial redundancy in the video sequence. Traditional block motion compensation schemes basically assume that objects in a scene undergo a displacement in the x- and y-directions from one frame to the next. Motion vectors are signaled from the encoder to the decoder to describe this motion. The decoder then uses the motion vectors to predict current frame data from previous reference frames.

Because I-frames can be decoded without a reference frame, a decoder can start decoding correctly at any I-frame. Therefore, in many encoders, I-frames are periodically inserted in a coded video stream to serve as entry points. These periodic I-frames can cause visible coding artifacts in the video stream. More specifically, there may be discrepancies in picture quality between successive I-frames and P-frames due to coding noise. These discrepancies are categorized in two patterns. In one pattern, picture quality of an I-frame is higher than that of a P-frame and the quality reduces gradually over P-frames. In the other pattern, the opposite is true. In both patterns, the image content from a reconstructed P-frame and the following I-frame may be seen differently by human eyes even if the image content is similar objects in the original frames. These periodic discrepancies are perceived as annoying visible artifacts, which may be referred to as breathing or flicker artifacts.

Several prior techniques have been developed to reduce flicker artifacts. In some techniques, the cost functions used to choose the appropriate intra prediction mode are modified to reduce the flicker artifacts. In addition, in some techniques, the quantization parameter is repeatedly reduced until flicker artifacts become lower than a threshold. In another technique, the inter-coded image for a macroblock is derived from a previous P-frame. Then, a detent position is computed from the inter-coded image and detented quantization is performed based on the detent position. Another technique applies a filter to the original frames prior to encoding.

### BRIEF DESCRIPTION OF THE DRAWINGS

Particular embodiments in accordance with the invention will now be described, by way of example only, and with reference to the accompanying drawings:

FIG. 1 shows a block diagram of a digital system in accordance with one or more embodiments of the invention;

FIG. 2 shows a block diagram of a video encoder in accordance with one or more embodiments of the invention;

FIG. 3 shows a block diagram of an I-frame encoding system in accordance with one or more embodiments of the invention;

FIG. 4A shows a flow diagram of a method in accordance with one or more embodiments of the invention;

FIG. 4B shows an example of previous frame selection in accordance with one or more embodiments of the invention; and

FIGS. 5-7 show illustrative digital systems in accordance with one or more embodiments of the invention.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

Certain terms are used throughout the following description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. In addition, although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

Further, embodiments of the invention should not be considered limited to any particular video coding standard. In addition, for convenience in describing embodiments of the invention, the term frame may be used to refer to the portion of a video sequence being encoded. One of ordinary skill in the art will understand embodiments of the invention that operate on subsets of frames such as, for example, a slice, a field, a video object plane, etc. Further, one of ordinary skill in the art will understand that block-based encoding of frames (or subsets thereof) operates on blocks of pixels in a frame that may be referred to as coding units, image blocks, macroblocks, etc. For convenience in describing some embodiments of the invention, the term macroblock is used herein.

In general, embodiments of the invention provide for reduction of flicker artifacts during encoding of a video sequence. In general, in one or more embodiments of the invention, a current frame is encoded as I-frame by, for each macroblock in the current frame, selectively intra-coding the macroblock from the current frame or a corresponding reconstructed macroblock from the previous P-frame, i.e., the reconstructed frame of the previous P-frame. More specifically, a macroblock in the current frame may be replaced by a motion-compensated corresponding macroblock from the previous P-frame if the macroblock in the current frame is determined to contribute to flicker. This determination is made by performing motion estimation on the macroblock in the current frame using the previous original frame that was encoded as the previous P-frame in the video sequence as the reference frame. If a motion estimation measure, e.g., sum-of-absolute-differences (SAD), computed for the macroblock selected during motion estimation is smaller than an adaptive motion threshold, the macroblock in the current frame is replaced by the motion-compensated corresponding macroblock in the previous P-frame for encoding.

The adaptive threshold may be computed as an average of the motion estimation measures, e.g., an average of SADs of macroblocks in the previous P-frame. To generate the motion-compensated macroblock, motion compensation is performed on the corresponding macroblock from the previous P-frame using the motion vector obtained from the motion estimation. In some embodiments of the invention, the motion-compensated macroblock is encoded with smaller quantization parameter that would be used for the original macroblock to make it as similar as possible to the macroblock in the previous P-frame.

Many prior art flicker reduction techniques require quantization, transformation, inverse-quantization, and inverse-transformation to be performed. Embodiments of the invention do not require this level of computation and can be performed in a single encoding pass. Further, in implementation, if the target digital system has dedicated components for motion estimation and motion compensation, these components may be used to implement flicker reduction as described herein as the components would typically be idle during I-frame encoding.

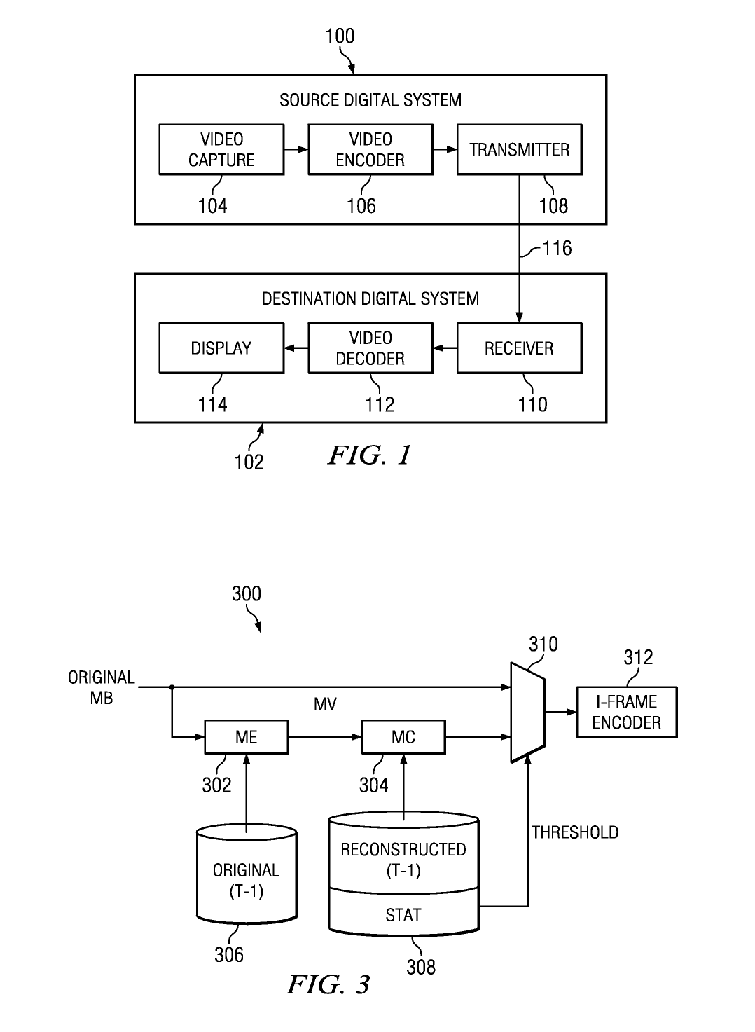

FIG. 1 shows a block diagram of a digital system in accordance with one or more embodiments of the invention. The digital system is configured to perform coding of digital video sequences using embodiments of the methods described herein. The system includes a source digital system (100) that transmits encoded video sequences to a destination digital system (102) via a communication channel (116). The source digital system (100) includes a video capture component (104), a video encoder component (106) and a transmitter component (108). The video capture component (104) is configured to provide a video sequence to be encoded by the video encoder component (106). The video capture component (104) may be for example, a video camera, a video archive, or a video feed from a video content provider. In some embodiments of the invention, the video capture component (104) may generate computer graphics as the video sequence, or a combination of live video and computer-generated video.

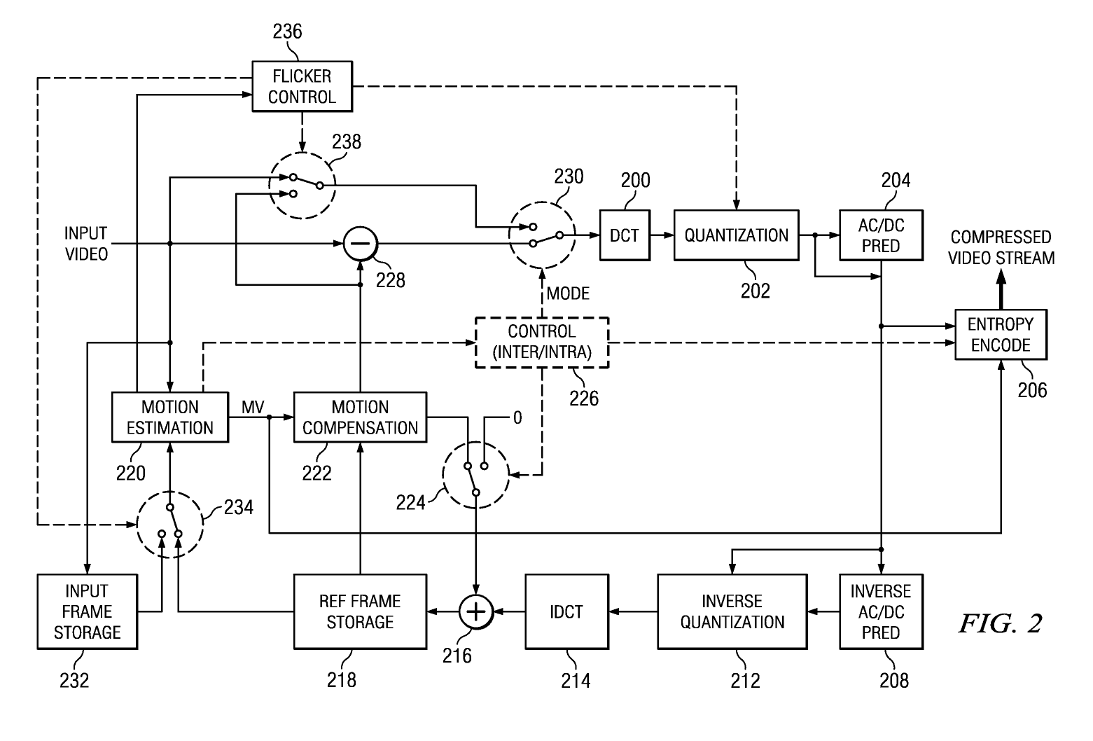

The video encoder component (106) receives a video sequence from the video capture component (104) and encodes it for transmission by the transmitter component (1108). In general, the video encoder component (106) receives the video sequence from the video capture component (104) as a sequence of frames, divides the frames into coding units which may be a whole frame or a part of a frame, divides the coding units into blocks of pixels, and encodes the video data in the coding units based on these blocks. During the encoding process, a method for flicker artifact reduction in accordance with one or more of the embodiments described herein may be used. The functionality of embodiments of the video encoder component (106) is described in more detail below in reference to FIG. 2.

The transmitter component (108) transmits the encoded video data to the destination digital system (102) via the communication channel (116). The communication channel (116) may be any communication medium, or combination of communication media suitable for transmission of the encoded video sequence, such as, for example, wired or wireless communication media, a local area network, or a wide area network.

The destination digital system (102) includes a receiver component (110), a video decoder component (112) and a display component (114). The receiver component (110) receives the encoded video data from the source digital system (100) via the communication channel (116) and provides the encoded video data to the video decoder component (112) for decoding. In general, the video decoder component (112) reverses the encoding process performed by the video encoder component (106) to reconstruct the frames of the video sequence. The reconstructed video sequence may then be displayed on the display component (114). The display component (114) may be any suitable display device such as, for example, a plasma display, a liquid crystal display (LCD), a light emitting diode (LED) display, etc.

In some embodiments of the invention, the source digital system (100) may also include a receiver component and a video decoder component and/or the destination digital system (102) may include a transmitter component and a video encoder component for transmission of video sequences both directions for video steaming, video broadcasting, and video telephony. Further, the video encoder component (106) and the video decoder component (112) may perform encoding and decoding in accordance with one or more video compression standards such as, for example, the Moving Picture Experts Group (MPEG) video compression standards, e.g., MPEG-1, MPEG-2, and MPEG-4, the ITU-T video compression standards, e.g., H.263 and H.264, the Society of Motion Picture and Television Engineers (SMPTE) 421 M video CODEC standard (commonly referred to as “VC-1”), the video compression standard defined by the Audio Video Coding Standard Workgroup of China (commonly referred to as “AVS”), etc. The video encoder component (106) and the video decoder component (112) may be implemented in any suitable combination of software, firmware, and hardware, such as, for example, one or more digital signal processors (DSPs), microprocessors, discrete logic, application specific integrated circuits (ASICs), field-programmable gate arrays (FPGAs), etc.

FIG. 2 shows a block diagram of a video encoder, e.g., the video encoder (106) of FIG. 1, in accordance with one or more embodiments of the invention. More specifically, FIG. 2 shows the basic coding architecture of an MPEG-4 video encoder configured to perform methods in accordance with one or more embodiments as described herein. One of ordinary skill in the art will understand video encoder embodiments for other coding standards.

In the video encoder of FIG. 2, frames of an input digital video sequence are provided as one input of a motion estimation component (220), as one input of a mode conversion switch (238), as an input to the input frame storage component (232), and as one input to a combiner (228) (e.g., adder or subtractor or the like). The reference frame storage component (218) provides reference data as one input to a reference frame selection switch (234) and to the motion compensation component (222). The reference data from the reference frame storage component (218) may include one or more previously encoded and decoded, i.e., reconstructed frames. For inter-coded frames, the reference data provided to the motion compensation component (222) is from the previous reconstructed frame. For intra-coded frames, the reference data provided to the motion compensated component (222) is from the previous reconstructed P-frame. The input frame storage component (232) provides reference data as one input of the reference frame selection switch (234). The reference data from the input frame storage component (232) are previously received frames of the original input digital video sequence.

The reference frame selection switch (234) provides reference data to the motion estimation component (220) based on a coding mode selected by the motion estimation component (220). If the current input video frame is to be coded as an I-frame, the flicker control component (236) will set the reference frame selection switch (234) to provide a previous original frame of the input digital sequence, i.e., the frame that immediately preceded the current frame, as the reference data. Otherwise, the flicker control component (236) will set the reference frame selection switch (234) to receive reference data from the reference frame storage (218).

The motion estimation component (220) provides motion estimation information to the motion compensation component (222), the mode control component (226), the flicker control component (236), and the entropy encode component (206). More specifically, the motion estimation component (220) processes each macroblock in a frame and performs searches based on the prediction modes defined in the standard to choose the best motion vector(s)/prediction mode for each macroblock. A search is performed to identify a macroblock (MB) in a reference frame that is most similar to the MB being processed. The MB in the reference frame is identified by computing a motion estimation measure, e.g., a SAD, between the MB being processed and MBs in the reference frame. The MB in the reference frame with the best motion estimation measure is selected for computation of the motion vector(s) (MV). The motion estimation component (220) provides the selected MV(s) to the motion compensation component (222), and the entropy encode component (206), and the selected prediction mode to the mode control component (226). The motion estimation component (220) also provides the motion estimation measure of the selected MB and an average motion estimation measure, e.g., an average SAD, for the previous P-frame to the flicker control component (236).

In one or more embodiments of the invention, the motion estimation component (220) is configured to compute the average motion estimation measure for a P-frame as the MBs of the P-frame are processed. In some embodiments of the invention, the motion estimation measure used for motion estimation is a SAD computation between the current MB and MBs within a search window of a reference frame. In such embodiments, the average motion estimation measure is the average of the SADs of the selected reference MBs used in encoding the previous P-frame. In some such embodiments, only SADs less than an empirically determined flicker threshold (e.g., 3000) are included in the computation of the average SAD. Reference macroblocks that result in a SAD less than the flicker threshold are likely to contribute to flicker artifacts in the encoded video stream. Further, in some embodiments of the invention, if the average SAD is less than another empirically determined minimum threshold (e.g., 500), the average SAD is set to the empirically determined minimum threshold.

The mode control component (226) controls the two mode conversion switches (224, 230) based on the prediction modes provided by the motion estimation component (220). When an interprediction mode is provided to the mode control component (226), the mode control component (226) sets the mode conversion switch (230) to feed the output of the combiner (228) to the DCT component (200) and sets the mode conversion switch (224) to feed the output of the motion compensation component (222) to the combiner (216). When an intraprediction mode is provided to the mode control component (226), the mode control component (226) sets the mode conversion switch (230) to feed input frames to the DCT component (200) and sets the mode conversion switch (224) to feed the output of the motion compensation component (222) to a null output.

The motion compensation component (222) provides motion compensated prediction information based on the motion vectors received from the motion estimation component (220) as one input to the combiner (228) and to the mode conversion switch (224). When an I-picture is being encoded, the motion compensation component (222) provides motion compensated prediction information as one input to the flicker control switch (238). Note that I-picture encoding does not use the motion compensation output to the switch 228. The motion compensated prediction information includes a block of motion compensated pixels of the same size as the original macroblock (e.g., 16×16) generated using the motion vector from the motion estimation component (220).

The combiner (228) subtracts the received prediction macroblock from the current macroblock of the current input frame to provide a residual macroblock to the mode conversion switch (230). The resulting residual macroblock is a set of pixel difference values that quantify differences between pixel values of the original macroblock and the prediction macroblock.

The flicker control component (236) controls whether the current original MB or the motion-compensated MB from the motion-estimation component (228) will be encoded for an I-frame. More specifically, the flicker control component (236) compares the motion estimation measure of the selected MB from the previous original frame and the average motion estimation measure to determine if the current original MB will contribute to flicker in the encoded video sequence. If the motion estimation measure is less than the average motion estimation measure, the current original MB is determined to contribute to flicker and the flicker control component (236) sets the flicker control switch (238) to provide the motion-compensated MB from the motion compensation component (228) to the mode conversion switch (230). The flicker control component (236) also sends control information to the quantization component (202) to cause the quantization component to reduce the quantization parameter that would have been used to code the original input macroblock. Otherwise, the flicker control component (236) set the flicker control switch (238) to provide the current original MB to the mode conversion switch (230). Note that the since the average motion estimation measure is computed for each P-frame, it may be different each time an I-frame is encoded and thus can be viewed as an adaptive threshold for determining whether or not flicker reduction is applied to a MB.

The mode conversion switch (230) then provides either the residual macroblock from the combiner (228) or the macroblock from the flicker control switch (238) to the DCT component (200) based on the current prediction mode. The DCT component (200) performs a block transform, e.g., discrete cosine transform (DCT), on the macroblock and outputs the transform result. The transform result is provided to a quantization component (202) which outputs quantized transform coefficients. If the transform coefficients to be quantized are from the motion compensated MB (as signaled by the flicker control component (236)), the quantization parameter used is reduced by an empirically determined amount (e.g., 9) from the quantization parameter that would have been used to quantize the transform coefficients from the current original MB. The quantized transform coefficients are provided to the DC/AC (Discrete Coefficient/Alternative Coefficient) prediction component (204). AC is typically defined as a DCT coefficient for which the frequency in one or both dimensions is non-zero (higher frequency). DC is typically defined as a DCT coefficient for which the frequency is zero (low frequency) in both dimensions.

The AC/DC prediction component (204) predicts the AC and DC for the current macroblock based on AC and DC values of adjacent macroblocks such as an adjacent left top macroblock, a top macroblock, and an adjacent left macroblock. More specifically, the AC/DC prediction component (204) calculates predictor coefficients from quantized coefficients of neighboring macroblocks and then outputs the differentiation of the quantized coefficients of the current macroblock and the predictor coefficients. The differentiation of the quantized coefficients is provided to the entropy encode component (206), which encodes them and provides a compressed video bit stream for transmission or storage. The entropy coding performed by the entropy encode component (206) may be any suitable entropy encoding techniques, such as, for example, context adaptive variable length coding (CAVLC), context adaptive binary arithmetic coding (CABAC), run length coding, etc.

Inside every encoder is an embedded decoder. As any compliant decoder is expected to reconstruct an image from a compressed bit stream, the embedded decoder provides the same utility to the video encoder. Knowledge of the reconstructed input allows the video encoder to transmit the appropriate residual energy to compose subsequent frames. To determine the reconstructed input, the quantized transform coefficients from the quantization component (202) are provided to an inverse quantize component (212) which outputs estimated transformed information, i.e., an estimated or reconstructed version of the transform result from the DCT component (200). The estimated transformed information is provided to the inverse DCT component (214), which outputs estimated residual information which represents a reconstructed version of the residual macroblock. The reconstructed residual macroblock is provided to a combiner (216). The combiner (216) adds the predicted macroblock from the motion compensation component (222) (if available) to the reconstructed residual macroblock to generate an unfiltered reconstructed macroblock, which becomes part of reconstructed frame information. The reconstructed frame information, i.e., reference frame, is stored in the frame storage component (218) which provides the reconstructed frame information as reference frames to the motion estimation component (220) and the motion compensation component (222).

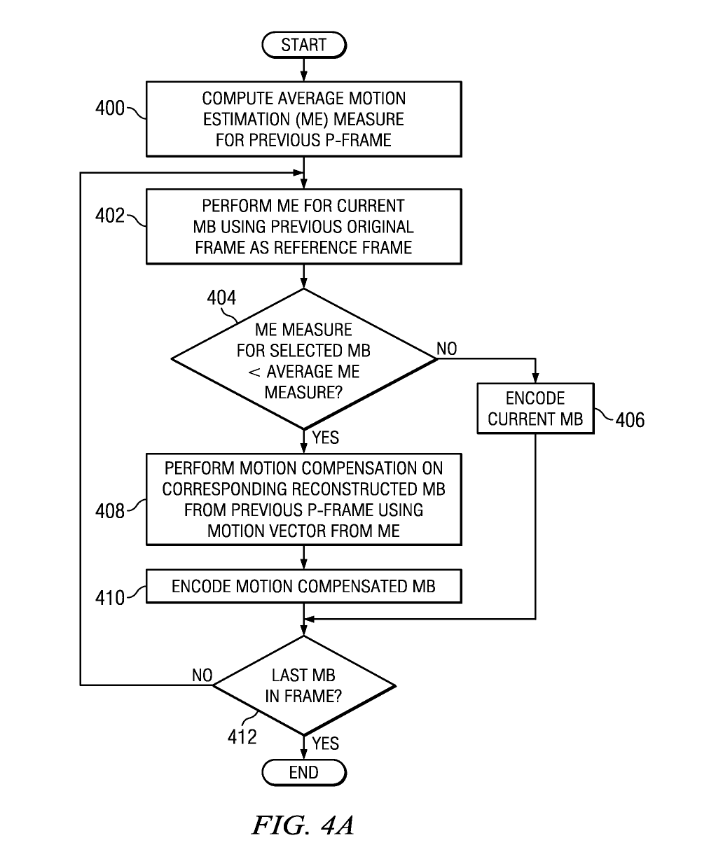

FIG. 3 shows a block diagram of an I-frame encoding system (300) in accordance with one or more embodiments of the invention. In one or more embodiments of the invention, the I-frame encoding system (300) is implemented as part of a video encoder that performs block-based motion estimation/compensation. Such a video encoder may use the I-frame encoding system for encoding I-frames and include other components with functionality similar to that described above in reference to FIG. 2 for encoding inter-coded frames. The I-frame encoding system (300) processes each original MB (e.g., a coding unit of 16x16 pixels) of an input frame T of a video sequence to encode the input frame as an I-frame. The I-frame encoding system (300) includes a motion estimation component (302), a motion compensation component (304), a flicker reduction control component (310), a memory (306) storing an original frame of the video sequence preceding the input frame being encoded, e.g., input frame T-1, and a memory (308) storing the reconstructed frame created by decoding the original frame after encoding, e.g., reconstructed frame T-1, and statistics, e.g., an adaptive threshold, generated during encoding of the reconstructed frame. The notation T and T-1 is used for convenience in explanation. In embodiments of the invention, the original frame need not be the frame immediately preceding the input frame in the video sequence.

In one or more embodiments of the invention, the previous original frame T-1 is encoded as a P-frame. Thus, the reconstructed frame (T-1) is created by decoding a P-frame. Further, during the encoding of the previous original frame T-1, the adaptive threshold is computed as an average motion estimation measurement and stored in the memory (308). In some embodiments of the invention, the motion estimation measure used for motion estimation for the previous original frame T-1 is a SAD computation between the current MB and MBs within a search window of a reference frame. In such embodiments, the average motion estimation measure is the average of the SADs of the selected reference MBs used in encoding the previous original frame T-1 as a P-frame. In some such embodiments, only SADs less than an empirically determined flicker threshold (e.g., 3000) are included in the computation of the average SAD. Reference MBs that result in a SAD less than the flicker threshold are likely to contribute to flicker artifacts in the encoded video stream. Further, in some embodiments of the invention, if the average SAD is less than another empirically determined minimum threshold (e.g., 500), the average SAD is set to the empirically determined minimum threshold.

Referring again to FIG. 3, the motion estimation component (302) is configured to perform block-based motion estimation for the current original MB from frame T using the previous original frame (T-1) as the reference frame. A search is performed to identify a macroblock (MB) in the previous original frame (T-1) that is most similar to the current original MB. The MB in the previous original frame (T-1) is identified by computing a motion estimation measure between the current original MB and MBs in the previous original frame (T-1) frame. The MB in the previous original frame (T-1) with the best motion estimation measure is selected for computation of a motion vector. In one or more embodiments of the invention, the motion estimation measure used for motion estimation is a SAD computation between the current original MB and MBs within a search window of the previous original frame (T-1). The motion estimation component (302) provides the computed motion vector (MV) to the motion compensation component (304). Although not specifically shown in FIG. 3, the motion estimation component (302) also provides the motion estimation measure for the selected MB from the previous original frame (T-1) to the flicker reduction control component (310).

The motion compensation component (310) is configured to perform motion compensation on a reconstructed MB in the reconstructed frame (T-1) using the MV provided by the motion estimation component (302). The reconstructed MB is taken from the same location in the reconstructed frame (T-1) as the selected MB in the previous original frame (T-1), i.e., the reconstructed MB is the decoded version of the selected MB. The motion compensation component (304) provides the motion-compensated MB to the flicker reduction control component (310).

The flicker reduction control component (310) is configured to use the adaptive threshold to select one of the original MB and the motion-compensated MB to be coded. More specifically, the flicker control component (310) is configured to compare the adaptive threshold to the motion estimation measure from the motion estimation component (302) to determine if the original MB will contribute to flicker in the encoded video stream. If the motion estimation measure is less than the adaptive threshold, the flicker reduction control component (310) determines that the original MB will contribute to flicker and selects the motion-compensated MB for coding. Otherwise, the flicker reduction control component (310) selects the original MB for coding.

The I-frame encoder component (312) is configured to encode the MB selected by the flicker reduction control component (310) for inclusion in the encoded video sequence produced by the video encoder. In one or more embodiments of the invention, the I-frame encoder component (312) includes functionality as previously described for the DCT component (200), the quantization component (202), and the DC/AC component (204) of FIG. 2. If the transform coefficients to be quantized are from the motion-compensated MB, the quantization parameter used is reduced by an empirically determined amount (e.g., 9) from the quantization parameter that would have been used to quantize the transform coefficients from the original MB. In some embodiments of the invention, the I-frame encoding system (300) and the components for encoding inter-coded frames in the video encoder share components that perform the actual coding and decoding of macroblocks, e.g., a DCT component, a quantization component, an AC/DC prediction component, an entropy encode component, and embedded decoder components.

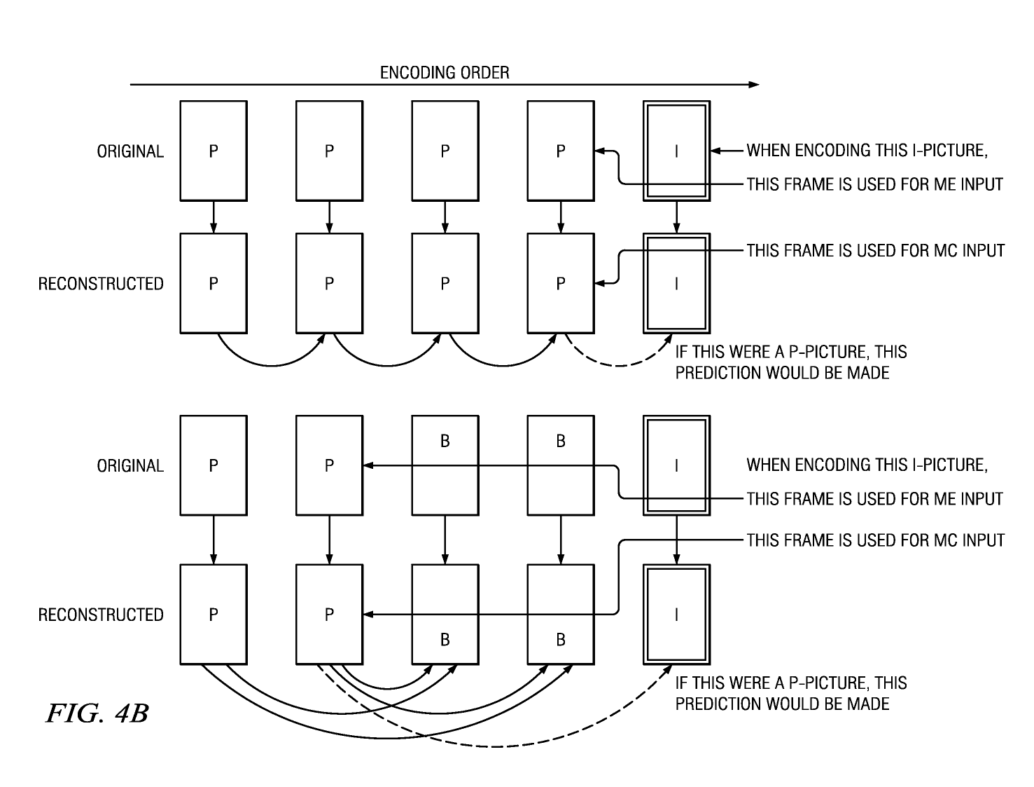

FIG. 4 is a flow graph of a method for flicker artifact reduction during encoding of a digital video sequence in accordance with one or more embodiments of the invention. The method of FIG. 4 is performed on an original input frame in the digital video sequence when that frame is to be encoded as an I-frame. Initially, an average motion estimation (ME) measure is computed for the previous P-frame, i.e., the last P-frame generated prior to the initiating encoding of the current input frame (400). In one or more embodiments of the invention, the average ME measure is computed during encoding of the previous P-frame. As part of encoding the previous P-frame, motion estimation is performed for each MB in the input frame being encoded to choose the best motion vector for the MB. A search is performed to identify a reference MB in a reference frame that is most similar to the MB being processed. The MB in the reference frame is identified by computing a motion estimation measure, e.g., a SAD, between the MB being processed and MBs in the reference frame. The MB in the reference frame with the best motion estimation measure is selected for computation of the motion vector (MV).

The average ME measure is computed as the average of the ME measures of the macroblocks selected during motion estimation. In embodiments of the invention in which the ME measure used for motion estimation is a SAD computation, the average motion estimation measure is the average of the SADs of the selected reference MBs. In some such embodiments, only SADs less than an empirically determined flicker threshold (e.g., 3000) are included in the computation of the average SAD. Reference macroblocks that result in a SAD less than the flicker threshold are likely to contribute to flicker artifacts in the encoded video stream. Further, in some embodiments of the invention, if the average SAD is less than another empirically determined minimum threshold (e.g., 500), the average SAD is set to the empirically determined minimum threshold.

After the average ME measure is computed, each MB in the frame is processed (412). First, motion estimation is performed for the current MB using a previous original input frame as the reference frame (402). The previous original input frame is the last previous original input frame in the input video sequence that was encoded as a P-frame. See FIG. 4B for examples of which previous original input frame may be selected as the reference frame for motion estimation.

Any suitable motion estimation technique may be used. In some embodiments of the invention, motion estimation includes performing a search to choose a MB for computation of a motion vector. The search identifies a reference MB in the previous original frame that is most similar to the current MB. The MB in the previous original frame is identified by computing an ME measure, e.g., a SAD, between the current MB and selected MBs in the previous original frame (e.g., MBs in a search window). The MB in selected MBs of the previous original frame with the best ME measure is selected for computation of the motion vector (MV).

If the ME measure of the selected MB is not less than the average ME measure computed for the previous P-frame (404), then the current MB is encoded (406). Otherwise, a macroblock is generated to be intra-coded instead of the current MB. That is, motion compensation (MC) is performed on a reconstructed frame generated from the previous P-frame using the motion vector computed during motion estimation to generate a motion-compensated MB (408). The reconstructed frame is generated by decoding the P-frame generated when encoding the previous original input frame. See FIG. 4B for examples of which reconstructed frame may be selected for used in motion compensation (MC). The motion-compensated MB is then encoded with a quantization parameter that is reduced by an empirically determined amount (e.g., 9) from the quantization parameter that would be used to encode the current MB (412).

Embodiments of the encoders and methods described herein may be provided on any of several types of digital systems: digital signal processors (DSPs), general purpose programmable processors, application specific circuits, or systems on a chip (SoC) such as combinations of a DSP and a reduced instruction set (RISC) processor together with various specialized programmable accelerators. A stored program in an onboard or external (flash EEP) ROM or FRAM may be used to implement the video signal processing. Analog-to-digital converters and digital-to-analog converters provide coupling to the real world, modulators and demodulators (plus antennas for air interfaces) can provide coupling for transmission waveforms, and packetizers can provide formats for transmission over networks such as the Internet.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

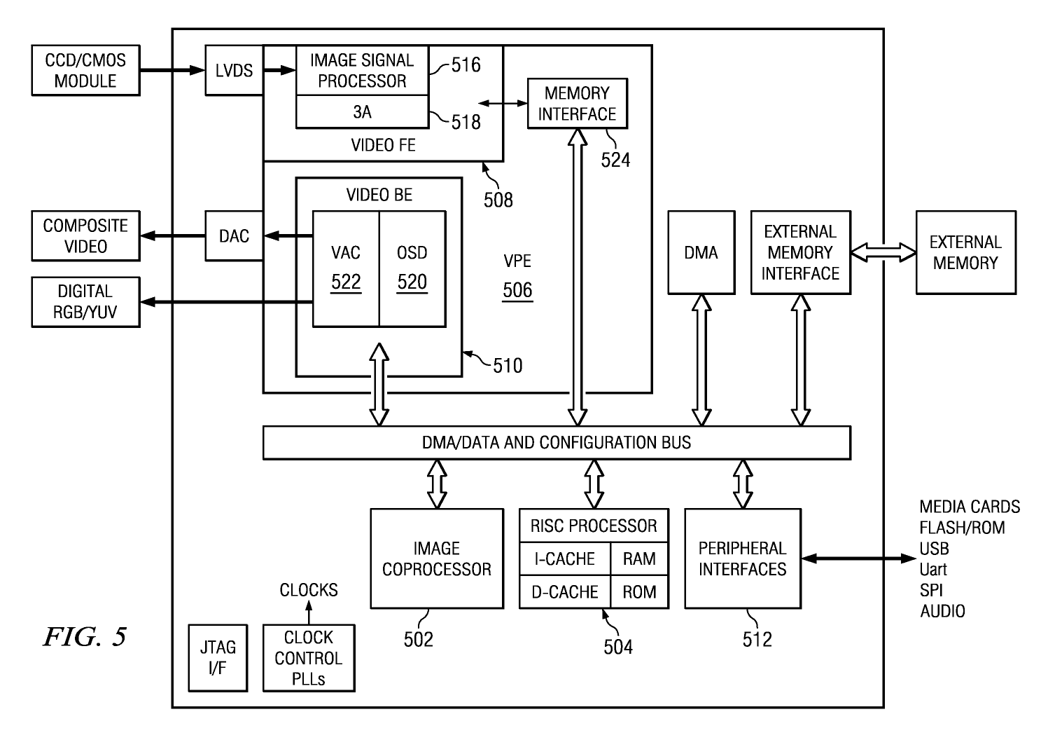

Embodiments of the methods and encoders as described herein may be implemented for virtually any type of digital system (e.g., a desk top computer, a laptop computer, a handheld device such as a mobile (i.e., cellular) phone, a personal digital assistant, a digital camera, etc.) with functionality to capture or otherwise generate digital video sequences. FIGS. 5-7 show block diagrams of illustrative digital systems.

FIG. 5 shows a digital system suitable for an embedded system (e.g., a digital camera) in accordance with one or more embodiments of the invention that includes, among other components, a DSP-based image coprocessor (ICP) (502), a RISC processor (504), and a video processing engine (VPE) (506) that may be configured to perform methods as described herein. The RISC processor (504) may be any suitably configured RISC processor. The VPE (506) includes a configurable video processing front-end (Video FE) (508) input interface used for video capture from imaging peripherals such as image sensors, video decoders, etc., a configurable video processing back-end (Video BE) (510) output interface used for display devices such as SDTV displays, digital LCD panels, HDTV video encoders, etc, and memory interface (524) shared by the Video FE (508) and the Video BE (510). The digital system also includes peripheral interfaces (512) for various peripherals that may include a multi-media card, an audio serial port, a Universal Serial Bus (USB) controller, a serial port interface, etc.

The Video FE (508) includes an image signal processor (ISP) (516), and a 3A statistic generator (3A) (518). The ISP (516) provides an interface to image sensors and digital video sources. More specifically, the ISP (516) may accept raw image/video data from a sensor (CMOS or CCD) and can accept YUV video data in numerous formats. The ISP (516) also includes a parameterized image processing module with functionality to generate image data in a color format (e.g., RGB) from raw CCD/CMOS data. The ISP (516) is customizable for each sensor type and supports video frame rates for preview displays of captured digital images and for video recording modes. The ISP (516) also includes, among other functionality, an image resizer, statistics collection functionality, and a boundary signal calculator. The 3A module (518) includes functionality to support control loops for auto focus, auto white balance, and auto exposure by collecting metrics on the raw image data from the ISP (516) or external memory.

The Video BE (510) includes an on-screen display engine (OSD) (520) and a video analog encoder (VAC) (522). The OSD engine (520) includes functionality to manage display data in various formats for several different types of hardware display windows and it also handles gathering and blending of video data and display/bitmap data into a single display window before providing the data to the VAC (522) in YCbCr format. The VAC (522) includes functionality to take the display frame from the OSD engine (520) and format it into the desired output format and output signals required to interface to display devices. The VAC (522) may interface to composite NTSC/PAL video devices, S-Video devices, digital LCD devices, high-definition video encoders, DVI/HDMI devices, etc.

The memory interface (524) functions as the primary source and sink to modules in the Video FE (508) and the Video BE (510) that are requesting and/or transferring data to/from external memory. The memory interface (524) includes read and write buffers and arbitration logic.

The ICP (502) includes functionality to perform the computational operations required for video encoding and other processing of captured images. The video encoding standards supported may include one or more of the JPEG standards, the MPEG standards, and the H.26x standards. In one or more embodiments of the invention, the ICP (502) is configured to perform the computational operations of flicker reduction methods as described herein.

In operation, to capture an image or video sequence, video signals are received by the video FE (508) and converted to the input format needed to perform video encoding. The video data generated by the video FE (508) is stored in then stored in external memory. The video data is then encoded by a video encoder and stored in external memory. During the encoding, a method for flicker reduction as described herein may be used. The encoded video data may then be read from the external memory, decoded, and post-processed by the video BE (510) to display the image/video sequence.

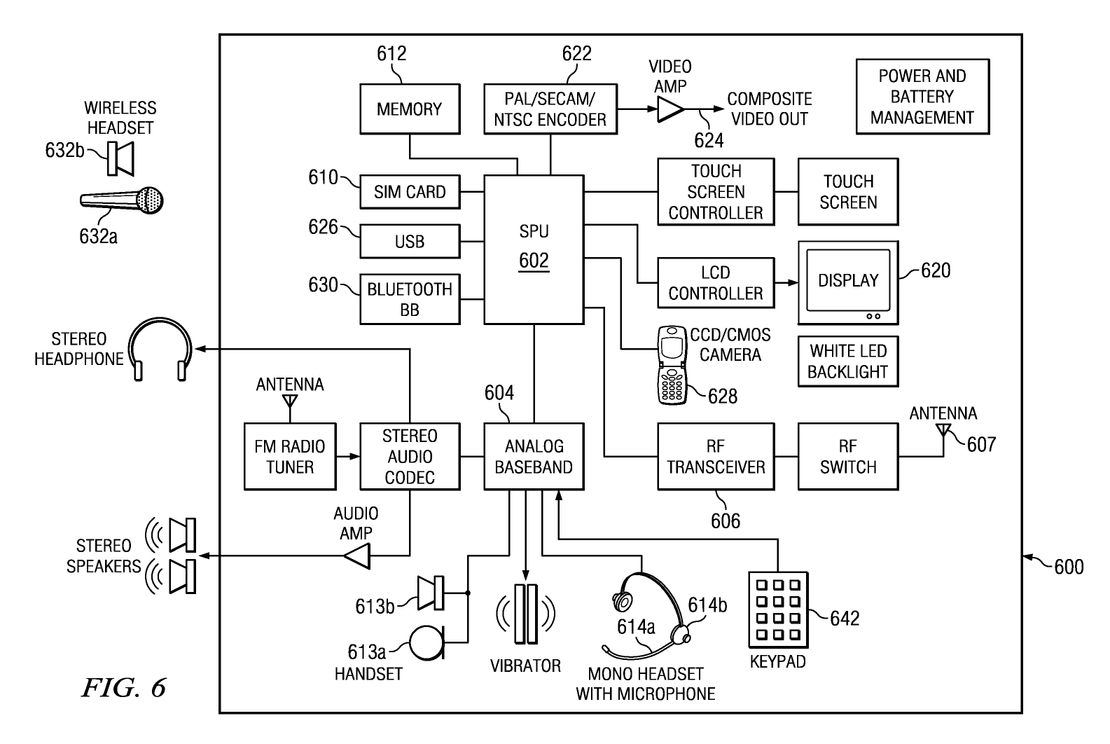

FIG. 6 is a block diagram of a digital system (e.g., a mobile cellular telephone) (600) that may be configured to perform the methods described herein. The signal processing unit (SPU) (602) includes a digital signal processing system (DSP) that includes embedded memory and security features. The analog baseband unit (604) receives a voice data stream from handset microphone (613a) and sends a voice data stream to the handset mono speaker (613b). The analog baseband unit (604) also receives a voice data stream from the microphone (614a) and sends a voice data stream to the mono headset (614b). The analog baseband unit (604) and the SPU (602) may be separate ICs. In many embodiments, the analog baseband unit (604) does not embed a programmable processor core, but performs processing based on configuration of audio paths, filters, gains, etc being setup by software running on the SPU (602).

The display (620) may also display pictures and video streams received from the network, from a local camera (628), or from other sources such as the USB (626) or the memory (612). The SPU (602) may also send a video stream to the display (620) that is received from various sources such as the cellular network via the RF transceiver (606) or the camera (626). The SPU (602) may also send a video stream to an external video display unit via the encoder (622) over a composite output terminal (624). The encoder unit (622) may provide encoding according to PAL/SECAM/NTSC video standards.

The SPU (602) includes functionality to perform the computational operations required for video encoding and decoding. The video encoding standards supported may include, for example, one or more of the JPEG standards, the MPEG standards, and the H.26x standards. In one or more embodiments of the invention, the SPU (602) is configured to perform the computational operations of a method for flicker reduction as described herein. Software instructions implementing the method may be stored in the memory (612) and executed by the SPU (602) as part of capturing and/or encoding of digital image data, e.g., pictures and video streams.

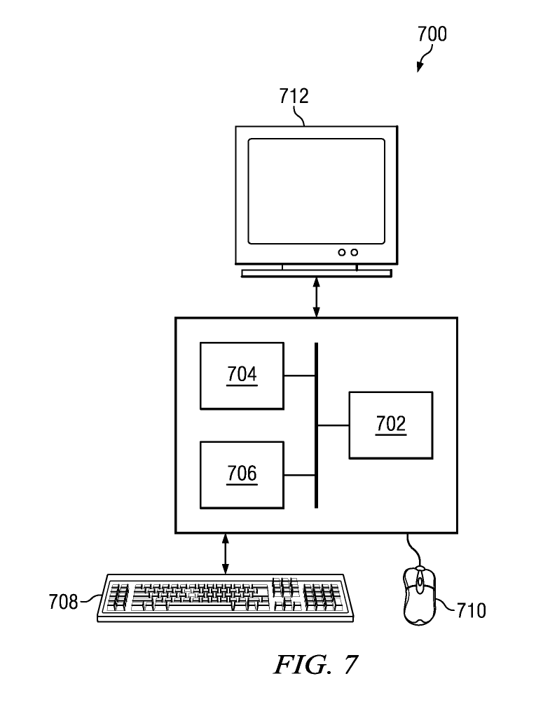

FIG. 7 shows a digital system (700) (e.g., a personal computer) that includes a processor (702), associated memory (704), a storage device (706), and numerous other elements and functionalities typical of digital systems (not shown). In one or more embodiments of the invention, a digital system may include multiple processors and/or one or more of the processors may be digital signal processors. The digital system (700) may also include input means, such as a keyboard (708) and a mouse (710) (or other cursor control device), and output means, such as a monitor (712) (or other display device). The digital system (700) may also include an image capture device (not shown) that includes circuitry (e.g., optics, a sensor, readout electronics) for capturing video sequences. The digital system (700) may include a video encoder with functionality to perform a method for flicker reduction as described herein. The digital system (700) may be connected to a network (714) (e.g., a local area network (LAN), a wide area network (WAN) such as the Internet, a cellular network, any other similar type of network and/or any combination thereof) via a network interface connection (not shown). Those skilled in the art will appreciate that the input and output means may take other forms.

Further, those skilled in the art will appreciate that one or more elements of the aforementioned digital system (700) may be located at a remote location and connected to the other elements over a network. Further, embodiments of the invention may be implemented on a distributed system having a plurality of nodes, where each portion of the system and software instructions may be located on a different node within the distributed system. In one embodiment of the invention, the node may be a digital system. Alternatively, the node may be a processor with associated physical memory. The node may alternatively be a processor with shared memory and/or resources.

Software instructions to perform embodiments of the invention may be stored on a computer readable medium such as a compact disc (CD), a diskette, a tape, a file, memory, or any other computer readable storage device. The software instructions may be distributed to the digital system (700) via removable computer readable media (e.g., floppy disk, optical disk, flash memory, USB key), via a transmission path from computer readable media on another digital system, etc.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. It is therefore contemplated that the appended claims will cover any such modifications of the embodiments as fall within the true scope and spirit of the invention.

What is claimed is:

1. A method of encoding a frame of a digital video sequence as an intracoded frame (I-frame), the method comprising:
performing motion estimation on a macroblock of the frame to compute a motion estimation measure and a motion vector for the macroblock, wherein a previous original frame of the digital video sequence that was encoded as a predictive coded frame (P-frame) is used as a reference frame; and
selectively encoding the macroblock or a motion-compensated macroblock from a reconstructed P-frame based on the motion estimation measure and an adaptive flicker threshold, wherein the reconstructed P-frame was generated by decoding the P-frame.

2. The method of claim 1, further comprising:
computing the adaptive filter threshold as an average of selected motion estimation measures computed during motion estimation performed during encoding of the P-frame.

3. The method of claim 2, wherein each motion estimation measure is computed as a sum-of-absolute-differences (SAD) between a macroblock in the previous original frame and a reference macroblock, and wherein a SAD is included in the average when the SAD is less than an empirically determined flicker threshold.

4. The method of claim 1, wherein selectively encoding comprises:
encoding the macroblock when the motion estimation measure is less than the adaptive flicker threshold; and
encoding the motion-compensated macroblock when the motion estimation measure not less than the adaptive flicker threshold.

5. The method of claim 1, further comprising:
generating the motion-compensated macroblock by performing motion compensation on the reconstructed P-frame using the motion vector.

6. The method of claim 1, wherein selectively encoding comprises reducing a quantization parameter by an empirically determined amount when the motion-compensated macroblock is selected for encoding.

7. A video encoder configured to encode a frame of a digital video sequence as an intracoded frame (I-frame), the video encoder comprising:
a memory configured to store a previous original frame of the digital video sequence;
a motion estimation component configured to perform motion estimation on a macroblock of the frame using the previous original frame to compute a motion estimation measure and a motion vector for the macroblock;
a motion compensation component configured to perform motion compensation on a reconstructed macroblock from a previous predictive coded frame (P-frame) using the motion vector to generate a motion-compensated macroblock, wherein the P-frame was generated by encoding the previous original frame; and
a flicker reduction control component configured to select one of the macroblock and the motion-compensated macroblock for encoding based on the motion estimation measure and an adaptive flicker threshold.

8. The video encoder of claim 7, wherein the motion estimation component is configured to compute the adaptive flicker threshold as an average of selected motion estimation measures computed when performing motion estimation for encoding of the previous P-frame.

9. The video encoder of claim 8, wherein the motion estimation component is configured to compute a motion estimation measure as a sum-of-absolute-differences (SAD) between a macroblock in the previous original frame and a reference macroblock, and to include a SAD in the average when the SAD is less than an empirically determined flicker threshold.

10. The video encoder of claim 7, wherein the flicker reduction control component is configured to select the macroblock for encoding when the motion estimation measure is less than the adaptive flicker threshold and to select the motion-compensated macroblock for encoding when the motion estimation measure not less than the adaptive flicker threshold.

11. The video encoder of claim 7, further comprising an I-frame encoder component configured to encode the macroblock using a first quantization parameter and to encode the motion-compensated macroblock using a second quantization parameter computed by reducing the first quantization parameter by an empirically determined amount.

12. A digital system configured to encode a frame of a digital video sequence as an intracoded frame (I-frame), the digital system comprising:
means for storing a previous original frame of the digital video sequence, a reconstructed frame generated by decoding a previous predictive coded frame (P-frame) generated by encoding the previous original frame, and an adaptive flicker threshold computed from selected motion estimation measures computed during encoding of the previous P-frame;
means for performing motion estimation on a macroblock of the frame to compute a motion estimation measure and a motion vector for the macroblock, wherein the previous original frame is used as a reference frame; and
means for selectively encoding the macroblock or a motion-compensated macroblock from the reconstructed frame based on the motion estimation measure and the adaptive flicker threshold.

13. The digital system of claim 12, wherein the means for selectively encoding comprises:
means for encoding the macroblock when the motion estimation measure is less than the adaptive flicker threshold; and
means for encoding the motion-compensated macroblock when the motion estimation measure not less than the adaptive flicker threshold.

14. The digital system of claim 12, further comprising means for performing motion compensation on a reconstructed macroblock of the reconstructed frame using the motion vector to generate the motion-compensated macroblock.

15. The digital system of claim 12, further comprising means for quantizing the macroblock using a first quantization parameter and quantizing the motion-compensated macroblock using a second quantization parameter computed by reducing the first quantization parameter by an empirically determined amount.

16. The digital system of claim 12, wherein each motion estimation measure in the selected motion estimation measures is computed as a sum-of-absolute-differences (SAD) between a macroblock in the previous original frame and a reference macroblock, and is selected for inclusion in computation of the adaptive flicker threshold when the SAD is less than an empirically determined flicker threshold.
